(19) United States
(12) Patent Application Publication
(10) Pub. No.: US 2025/0370943 A1
(43) Pub. Date: Dec. 4, 2025

(54) METHODS, SYSTEMS, ARTICLES OF MANUFACTURE, AND APPARATUS TO MANAGE STREAMING

(71) Applicant: Intel Corporation, Santa Clara, CA (US)

(72) Inventor: Kishore Kasichainula, Phoenix, AZ (US)

(73) Assignee: Intel Corporation, Santa Clara, CA (US)

(21) Appl. No.: 19/298,583

(22) Filed: Aug. 13, 2025

(51) Int. Cl. G06F 13/28

(52) U.S. Cl. CPC G06F 13/28; G06F 2213/28

(57) ABSTRACT

Systems, apparatus, articles of manufacture, and methods are disclosed to manage streaming. An example system includes interface circuitry and media access control (MAC) circuitry to route data from a network to a single address of a memory based on a memory address pointer at a scheduled rate.

### BACKGROUND

Streaming permits relatively large quantities of data to be transferred over a network. Direct Memory Access (DMA) is a technique of managing streaming activity. DMA streaming techniques facilitate hardware-based network data storage.

### BRIEF DESCRIPTION OF THE DRAWINGS

FIG. 1 is a block diagram of an example streaming environment in which example stream control circuitry operates to manage streaming in accordance with teachings disclosed herein.

FIG. 2 is a block diagram of an improved framework of DMA transmission.

FIG. 3 is a block diagram of an improved framework of DMA reception.

FIG. 4A is a block diagram of an example environment in which the example stream control circuitry of FIG. 1 operates to manage streaming in accordance with teachings disclosed herein.

FIG. 4B is a block diagram of an example implementation of the stream control circuitry of FIGS. 1 and 4A to manage streaming in accordance with teachings disclosed herein.

FIG. 5 is a table of an example transmit descriptor data structure and an example receive descriptor data structure utilized by the stream control circuitry of FIGS. 1, 4A and 4B to manage streaming in accordance with teachings disclosed herein.

FIG. 6 is a flowchart representative of example machine readable instructions and/or example operations that may be executed, instantiated, and/or performed by example programmable circuitry to implement the stream control circuitry of FIG. 4B.

FIG. 7 is a block diagram of an example processing platform including programmable circuitry structured to execute, instantiate, and/or perform the example machine readable instructions and/or perform the example operations of FIG. 6 to implement the stream control circuitry of FIG. 4B.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIG. 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Multiple field bus devices, such as Controller Area Network (CAN), or Local Interconnect Network (LIN) may be used to control data. Gigabit Multimedia Serial Link (GSML) may be used for transportation of video data (e.g., camera, display, etc.). In some cases, a number of separate field bus links are used for transportation of such audio/video data in high bandwidth applications. Additionally, applications that incorporate Time Sensitive Networking (TSN) standards and/or applications may incorporate Ethernet controllers because TSN provides precise scheduling of high bandwidth data traffic with different priorities on a single link. The use of Ethernet cables with Ethernet controllers also reduces weight and reduces the use of copper cabling, which is particularly beneficial in vehicle applications, some of which include over one mile of cable. Such reductions in the use of precious metals and their associated weight facilitate reduced fuel consumption.

As applications migrate from the distributed field buses to Ethernet based TSN networks, Ethernet TSN controllers may face latency thresholds (e.g., in view of safety systems such as collision avoidance warnings). For example, video streaming from a front-mounted camera for collision avoidance detection is expected to arrive at a corresponding vehicle electronic control unit (ECU) within a threshold latency duration (e.g., a latency window). TSN based solutions consistent with IEEE 802.1 guarantee latency between devices. However, there is no industry standard or solution to address latencies stemming from transportation of data within a system-on-a-chip (SOC) or within a host device (e.g., an SOC or host device to transport data between services and/or service devices (e.g., audio controllers (ACE), image processing units (IPUs), and/or displays). In some examples disclosed herein, an SOC is separate part of the host and/or a one of any number of SOCs within a system-in-package (SIP).

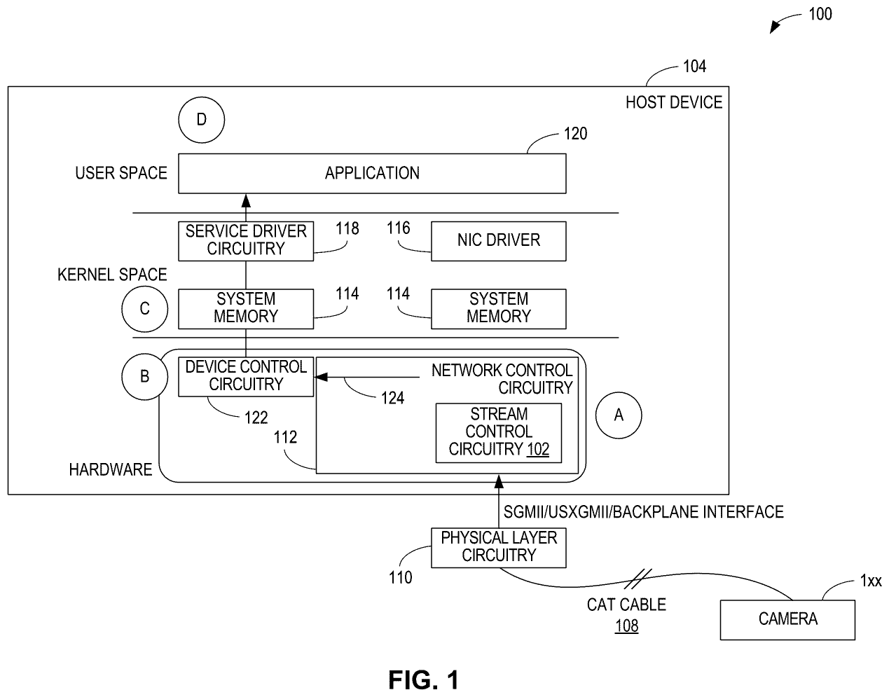

FIG. 1 is an example streaming environment 100 in which example stream control circuitry 102 manages streaming. The streaming environment 100 includes an example host device 104, an example service device 106 (e.g., a camera), an example Ethernet cable 108 (e.g., CAT cable), and example physical layer circuitry 110 (e.g., transceiver circuitry, Media Access Control (MAC) interface circuitry, etc.). The example host device 104 includes example network control circuitry 112, in which the stream control circuitry 102 may be implemented and/or otherwise integrated. The host device 104 includes example system memory 114, an example network interface controller (NIC) driver 116, example service driver circuitry 118 (e.g., an IPU driver), and example device control circuitry 122 (e.g., IPU control circuitry). The host 104 includes an example application 120, such as an application associated with a service (e.g., audio-based services, video-based services, etc.).

In some examples (e.g., SOC implementations of the host 104), device control circuitry 122 is independent with no direct interaction to the network control circuitry 112. As a result, data flow from the network control circuitry 112 to the application 120 exhibits particular end-to-end latencies based on Ethernet network packet processing. In some circumstances, a runtime end-to-end latency of audio over Ethernet is approximately 35 ms. This latency may be caused by, for example, performing several copy operations to process camera data over the Ethernet cable 108. A first data copy operation may occur when the network control circuitry 112 writes camera data into the system memory 114 (kernel space), a subsequent memory copy operation may involve the NIC driver 116 copying the data into a user space of the application 120. Then software corresponding to the application 120 may copy this data from network user space to camera user space. The service driver circuitry 118 (e.g., a camera driver) may copy this data from the user space to the kernel space before the device control circuitry 122 (e.g., IPU) fetches it for further processing.

Examples disclosed herein reduce the latency from the aforementioned 35 ms to, for example, under 1 ms by, in part, reducing software intervention and by establishing a hardware path 124 (e.g., bus, bus fabric, service interface circuitry, service I/O (SIO), etc.) between the example network control circuitry 112 and the example device control circuitry 122 (e.g., an IPU, an ACE, etc.). An example datapath in the illustrated example of FIG. 1 includes hardware path 124 from the network control circuitry 112 (“A”), to the device control circuitry 122 (“B”), to on-circuit system memory 114 (“C”) before reaching the application 120 (“D”). Additionally, examples disclosed herein facilitate direct memory access (DMA) without software intervention and/or computational burdens of a processor of the host device 104. Accordingly, examples disclosed herein may reduce in-circuit and/or SOC data latencies for packet-based data operations by diverting memory access operations from off-circuit memory (e.g., memory devices not included on the SOC) to in-circuit (e.g., also referred to herein as “on-circuit,” “on die,” or “on-board”) memory of the SOC. Memory access operations associated with the off-circuit memory exhibit a first latency, while memory access operations associated with the in-circuit memory exhibit a second latency less than the first latency. Such operations may include transfer of streaming data types associated with audio, video (e.g., camera sourced, display destination) over Ethernet. Such data types are periodic and exhibit characteristics of isosynchonicity (e.g., repeated data packets of a constant rate of data transfer with fixed gaps) in which retry transmission efforts are not needed.

As described in further detail below, examples disclosed herein implement a modified approach to DMA streaming that reads/writes data directly to on-board memory (e.g., within the network control circuitry 112, which may be implemented as an SOC), and bypasses, diverts, blocks, and/or otherwise prevents such data operations from occurring with main DDR memory.

In some circumstances, DMA transmission operations include a descriptor rings, data buffers (referred to herein as memory locations or DDR memory locations), and a MAC. The MAC may include a packet buffer and a descriptor buffer. The descriptor ring may include any number of descriptors, such as data structures containing information corresponding to packet header addresses, transmission time stamps, buffer lengths, header lengths, control bits, and status bits.

In some circumstances, DMA receive operations may be initiated by software of the application when there is any data to be transmitted or received. The NIC driver creates the descriptor ring(s) with each descriptor pointing to corresponding memory location(s) where the data is to be transmitted (in case of transmit) or written (in case of receive). A number of channels determines a corresponding number of descriptor rings created by the NIC driver. In some circumstances, the descriptor rings and packet data are stored in the main memory (DDR), which is located off-chip and/or otherwise not part of an SOC of the network control circuitry. Stated differently, the DDR is not connected to a bus of the SOC and, instead, traverses one or more additional off-SOC channels and/or networks to reach the DDR. In some circumstances, NIC hardware may fetch the descriptors (e.g., one descriptor per channel of stream data) in a burst and process them sequentially. After decoding one of the descriptors, the NIC may read or write the data into memory locations pointed to by the descriptors. In some circumstances, the memory locations pointed to by the descriptors are default memory pointers associated with DMA operations, in which the default memory pointers are not associated with memory within the SOC. Accordingly, memory access attempts to the default memory pointers are considered “off-chip” to the SOC.

The NIC may release the descriptors (e.g., one descriptor per channel) to software of the application once it completes the transfer of the data and then the software of the application reprocesses these released descriptors with new addresses pointing to new memory locations and gives ownership to the NIC by moving a tail pointer in the MAC. Some transmission and receive operations may exhibit heavy involvement of software and may include computational burdens outside of the network control circuitry (e.g., the SOC). Stated differently, the software may be responsible for repeatedly making descriptors with new memory locations and moving the tail pointers. Data (e.g., stream data) associated with relatively greater numbers of channels results in a similarly greater number of descriptors. Such repetitiveness adds latency that is further exacerbated by the software copying data from kernel space to user space or vice versa. Because software may assist the DMA efforts, corresponding computational burdens are extended to computational resources the software is using.

Examples disclosed herein take advantage of the periodic characteristics of data (e.g., streaming data associated with audio or video) to enable the network control circuitry 112 (e.g., within an SOC having one or more other circuit systems) to route (e.g., stream) the data directly to/from the device control circuitry 122 to/from memory on-board the SOC.

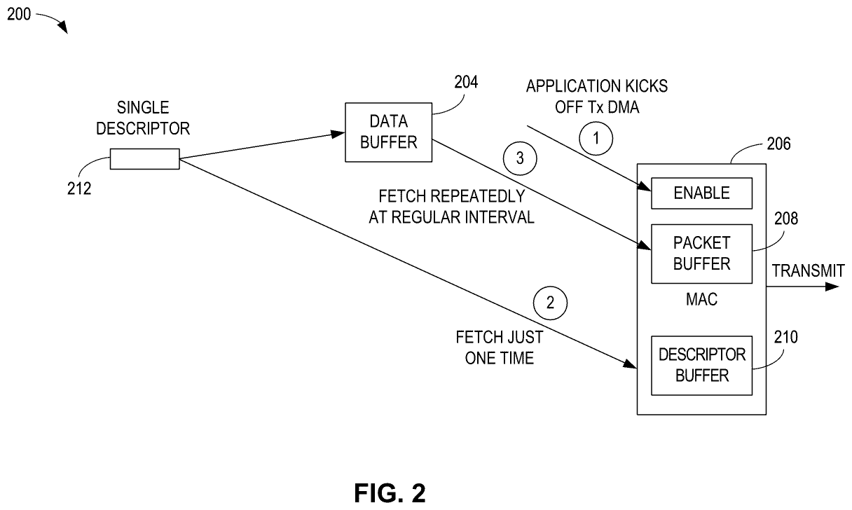

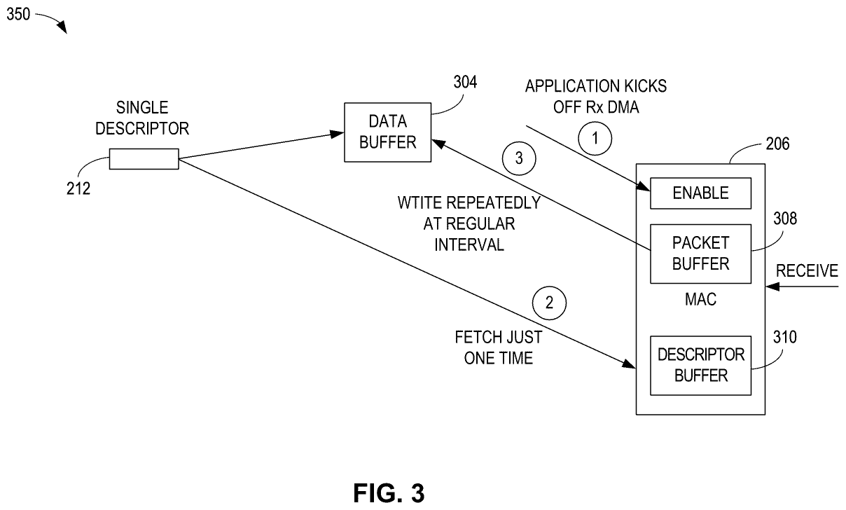

FIG. 2 illustrates an example framework 200 of improved DMA transmission operations to manage streaming, and FIG. 3 illustrates an example framework 350 of improved DMA receive operations to manage streaming. The example framework 300 of DMA transmission operations does not include a descriptor ring but instead includes a single descriptor 312 and a single data buffer 304 (e.g., a single memory location, such as static random-access memory (SRAM)), and a MAC 306. The MAC 306 includes a packet buffer 308 and a descriptor buffer 310. Unlike some circumstances where the descriptors grow in number based on a number of channels associated with data (e.g., stream data), the single descriptor 212 of FIGS. 2 and 3 is used for any number of channels associated with the stream data. Additionally, the single descriptor 212 of FIGS. 2 and 3 also include buffer address information corresponding to the single memory location 304 that is on-chip with the network control circuitry 112 rather than DDR memory stored off-chip. The framework 350 of DMA receive operations includes similar elements as described above in connection with the framework 200 of DMA transmission operations. Differences between transmission operations and receive operations are indicated with directional arrows.

In the illustrated example of FIG. 2, an application triggers a transmission request (“1”) to alert and/or otherwise inform the MAC 206 that streaming operations are to occur (e.g., a streaming mode). In some examples, the network control circuitry 112 generates a descriptor data structure, described in further detail below. In some examples, the example network control circuitry 112 fetches the single descriptor 212 once and causes read or write operations to the same on-circuit memory location 204 pointed to by the single descriptor 212. In some examples, to generate the descriptor 212, the network control circuitry 112 extracts and/or otherwise parses periodicity information from frame header information to identify a schedule (e.g., a periodicity schedule) for circuitry and systems of the SOC. In some examples, the network control circuitry 112 determines data packet types as synchronous or asynchronous. In some examples, the single descriptor 212 identifies a scheduled rate, such as a periodicity of transmission, (e.g., a 48 kHz audio use-case) used to configure the MAC 206 to cause read/write operations to occur at the designated schedule (e.g., a periodicity rate of 48 kHz).

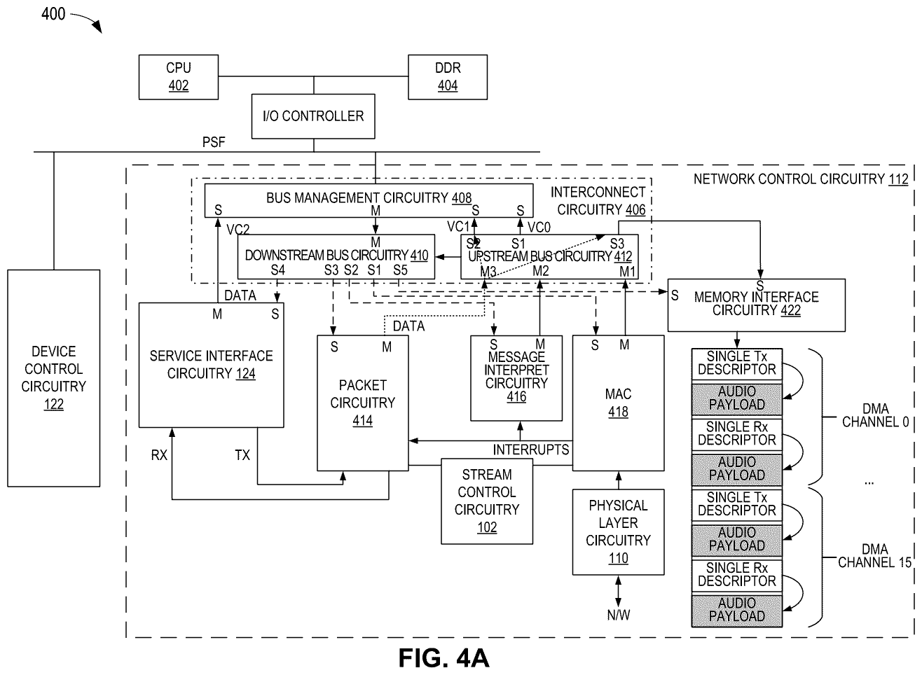

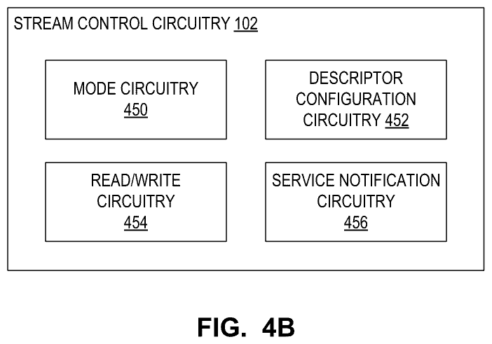

FIG. 4A is a block diagram of an example environment 400 in which the example network control circuitry 112 and example stream control circuitry 102 of FIG. 1 operates to manage streaming. In some examples, the stream control circuitry 102 is part of a DMA engine of the network control circuitry 112. The environment 400 includes the network control circuitry 112 communicatively connected to the device control circuitry 122, a CPU 402, an inter circuit bus 403, a host I/O controller 405, and DDR memory 404. In some examples, an I/O controller (also referred to as interconnect circuitry) 406 facilitates communication between the network control circuitry 112 and one or more of the CPU 402 and/or the DDR memory 404 (hereinafter “DDR”). In some examples, the network control circuitry 112 represents an SOC in which the example stream control circuitry 102 facilitates streaming management within the SOC.

The example network control circuitry 112 includes the stream control circuitry 102 and example interconnect circuitry 406. The interconnect circuitry 406 includes bus management circuitry 408, downstream bus circuitry 410, and upstream bus circuitry 412. The network control circuitry 112 includes the service interface circuitry 124 (e.g., the direct hardware path of FIG. 1), packet circuitry 414, message interrupt circuitry 416, a MAC 418, the physical layer circuitry 110, on-circuit SRAM 420, and memory interface circuitry 422. In operation, the example stream control circuitry 102 manages streaming of the example environment 400 in a manner that modifies traditional DMA streaming read/write operations. For example, and as described in further detail below, the stream control circuitry 102 causes DMA streaming to bypass, skip, divert, prevent and/or otherwise prohibit read/write operations to the DDR 404. In some examples, default memory pointers associated with traditional DMA streaming operations (e.g., default memory pointers that point to off-chip DDR 404) are replaced with memory address pointers (e.g., memory bypass pointers). In other words, examples disclosed herein divert read/write operations from default memory locations and/or off-chip locations to the on-circuit SRAM 420, thereby reducing latency during DMA operations.

FIG. 4B is a block diagram of an example implementation of the stream control circuitry 102 of FIGS. 1 and 4A to manage streaming. The stream control circuitry of FIG. 4B may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the stream control circuitry of FIG. 4B may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4B may, thus, be instantiated at the same or different times. Some or all of the circuitry of FIG. 4B may be instantiated, for example, in one or more threads executing concurrently on hardware and/or in series on hardware. Moreover, in some examples, some or all of the circuitry of FIG. 4B may be implemented by microprocessor circuitry executing instructions and/or FPGA circuitry performing operations to implement one or more virtual machines and/or containers.

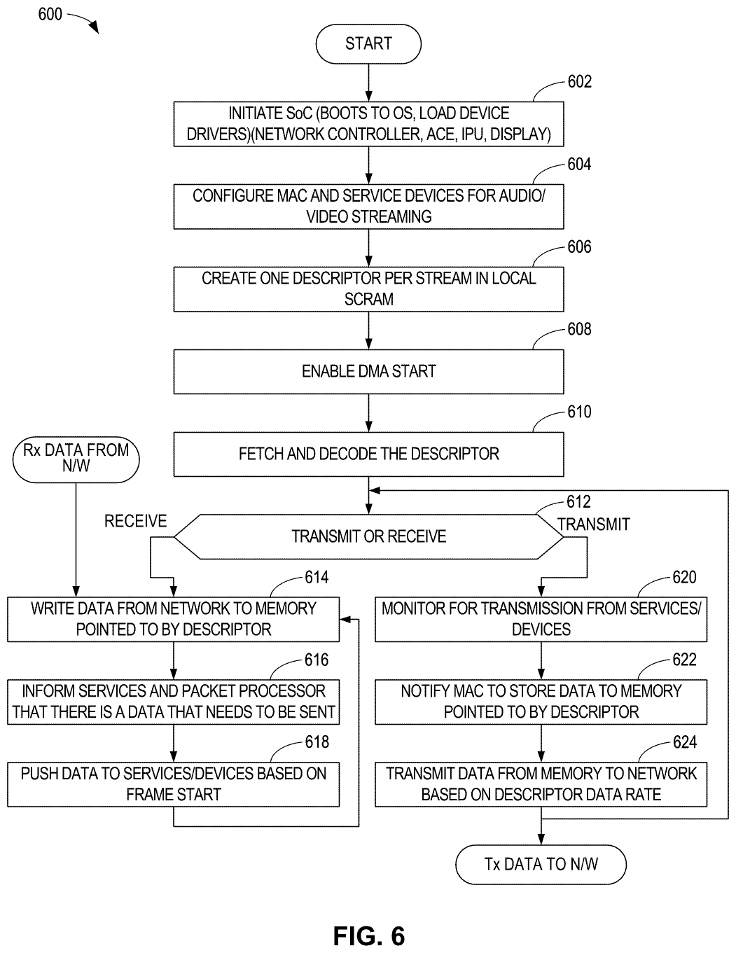

The example stream control circuitry 102 of FIG. 4B includes example mode circuitry 450, example descriptor configuration circuitry 452, example read/write circuitry 454, and example service notification circuitry 456. In some examples, the mode circuitry 450 is instantiated by programmable circuitry executing mode adjustment instructions and/or configured to perform operations such as those represented by the flowchart(s) of FIG. 6.

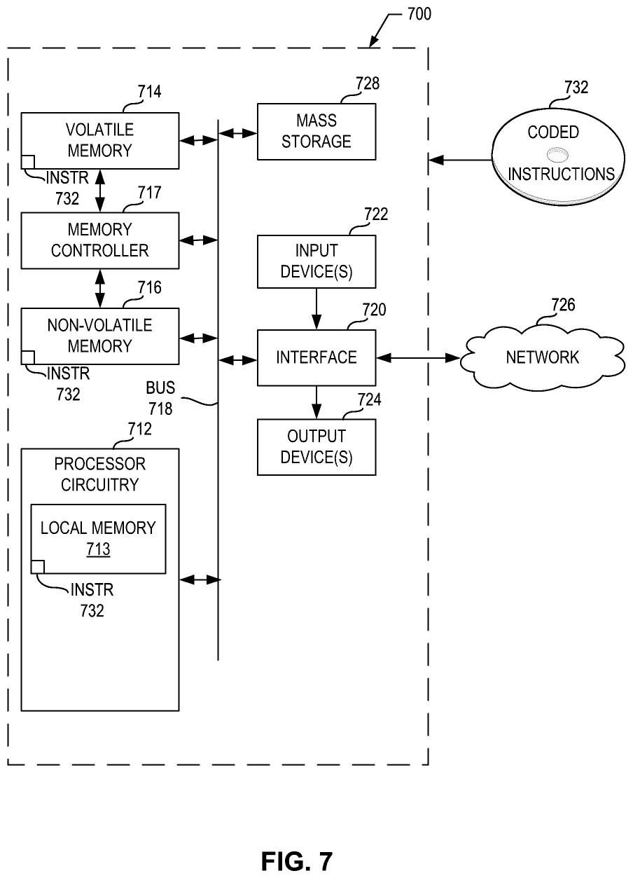

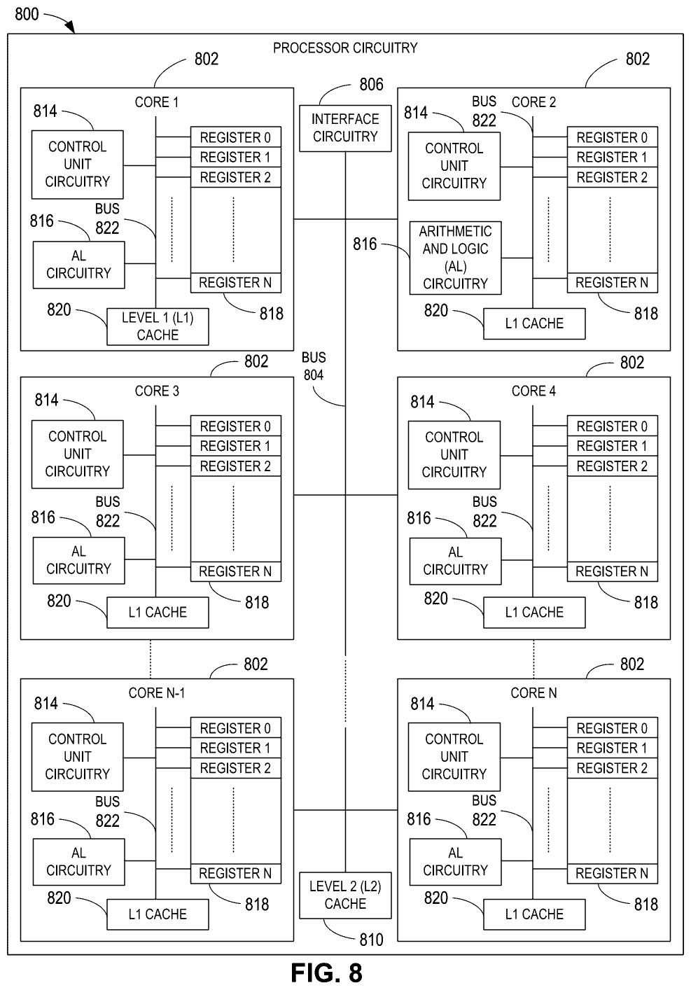

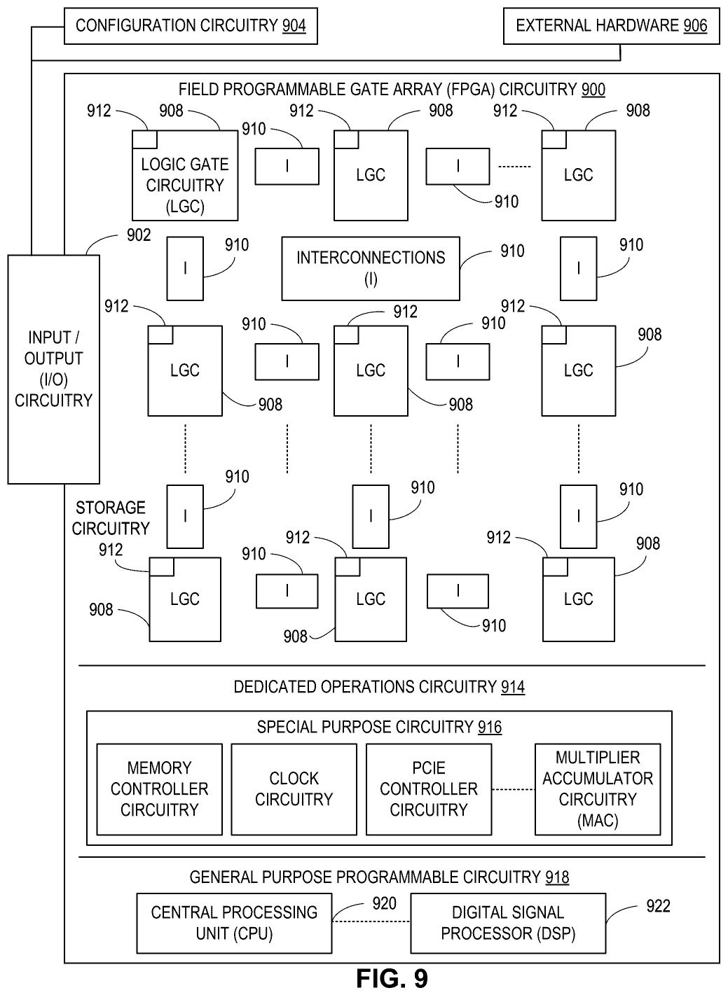

In some examples, the stream control circuitry includes means for adjusting a mode, or means for mode adjustment. For example, the means for adjusting a mode, or means for mode adjustment may be implemented by mode circuitry 450. In some examples, the mode circuitry 450 may be instantiated by programmable circuitry such as the example programmable circuitry 712 of FIG. 7. For instance, the mode circuitry 450 may be instantiated by the example microprocessor 800 of FIG. 8 executing machine executable instructions such as those implemented by at least blocks 604 and 608 of FIG. 6. In some examples, the mode circuitry 450 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the mode circuitry 450 may be instantiated by any other combination of hardware, software, and/or firmware. For example, the mode circuitry 450 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the descriptor configuration circuitry 452 is instantiated by programmable circuitry executing descriptor configuration instructions and/or configured to perform operations such as those represented by the flowchart(s) of FIG. 6.

In some examples, the stream control circuitry includes means for configuring a descriptor. For example, the means for configuring a descriptor may be implemented by descriptor configuration circuitry 452. In some examples, the descriptor configuration circuitry 452 may be instantiated by programmable circuitry such as the example programmable circuitry 712 of FIG. 7. For instance, the descriptor configuration circuitry 452 may be instantiated by the example microprocessor 800 of FIG. 8 executing machine executable instructions such as those implemented by at least blocks 606 and 610 of FIG. 6. In some examples, the descriptor configuration circuitry 452 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the descriptor configuration circuitry 452 may be instantiated by any other combination of hardware, software, and/or firmware. For example, the descriptor configuration circuitry 452 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the read/write circuitry 454 is instantiated by programmable circuitry executing read/write instructions and/or configured to perform operations such as those represented by the flowchart(s) of FIG. 6.

In some examples, the stream control circuitry includes means for transmission. For example, the means for transmission may be implemented by read/write circuitry 454. In some examples, the read/write circuitry 454 may be instantiated by programmable circuitry such as the example programmable circuitry 712 of FIG. 7. For instance, the read/write circuitry 454 may be instantiated by the example microprocessor 800 of FIG. 8 executing machine executable instructions such as those implemented by at least blocks 614, 622 and 624 of FIG. 6. In some examples, the read/write circuitry 454 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the read/write circuitry 454 may be instantiated by any other combination of hardware, software, and/or firmware. For example, the read/write circuitry 454 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the service notification circuitry 456 is instantiated by programmable circuitry executing service notification instructions and/or configured to perform operations such as those represented by the flowchart(s) of FIG. 6.

In some examples, the stream control circuitry includes means for notification. For example, the means for notification may be implemented by service notification circuitry 456. In some examples, the service notification circuitry 456 may be instantiated by programmable circuitry such as the example programmable circuitry 712 of FIG. 7. For instance, the service notification circuitry 456 may be instantiated by the example microprocessor 800 of FIG. 8 executing machine executable instructions such as those implemented by at least blocks 616, 618 and 620 of FIG. 6. In some examples, the service notification circuitry 456 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the service notification circuitry 456 may be instantiated by any other combination of hardware, software, and/or firmware. For example, the service notification circuitry 456 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Returning to the illustrated example of FIG. 4A, in operation the streaming environment 100, including a host device 104, is booted such that any number of on-board SOCs receive power. In some examples, the host device 104 boots to an operating system (OS) in which one or more device drivers are loaded (e.g., NIC device drivers, audio device drivers, video device drivers, display device drivers, etc.). In some examples, the mode circuitry 450 detects the type of data (e.g., synchronous data, asynchronous data) to be processed. Based on detection of streaming data (e.g., an indication/message from an application 120, detection by the physical layer circuitry 110, detection by the MAC 418, detection by the mode circuitry 450), the mode circuitry 450 configures and/or otherwise causes configuration of the MAC 418 and one or more service devices for streaming (e.g., audio/video streaming). Additionally, the mode circuitry 450 causes the packet circuitry 414 to operate in an isosynchronous mode. In particular, examples disclosed herein enable both traditional DMA techniques for circumstances of asynchronous traffic, as well as modified DMA techniques for circumstances of isosynchronous traffic, in which packet data exhibits a known and/or otherwise predetermined sample frequency (e.g., transmitted/received at a constant rate with a fixed time interval in between packets). For instance, while network traffic arriving at the physical layer circuitry 110 may be isosynchronous audio data from one or more microphones of an automobile, or isosynchronous video data from one or more cameras of the automobile, alternate asynchronous data may arrive at the physical layer circuitry 110 corresponding to events, such as collision avoidance warnings.

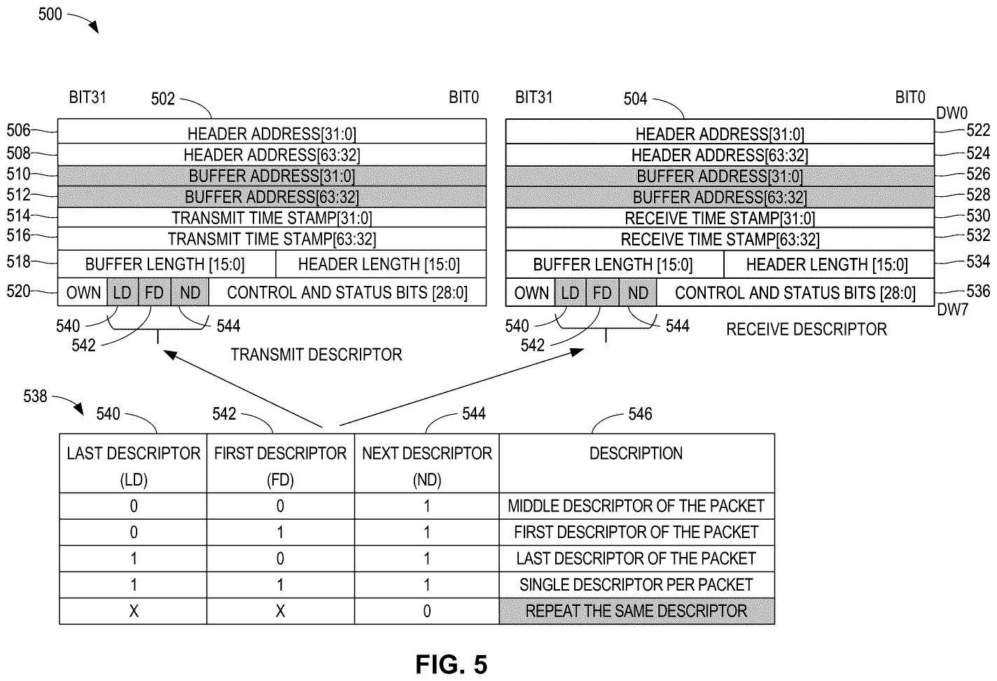

The example descriptor configuration circuitry 452 causes the network control circuitry 112 to create and/or otherwise generate one descriptor 312 per data portion (e.g., a stream of data, in which the stream may include any number of sub-portions (e.g., channels)), in which the generated descriptor 312 may be stored in the in-circuit SRAM 420. As described above and in further detail below, only a single memory address is read from or written to for a data portion, rather than two or more memory addresses associated with two or more descriptors of a descriptor ring. FIG. 5 is a table 500 including an example transmit descriptor 502 (a data structure) and an example receive descriptor 504 (a data structure). The example transmit descriptor 502 includes a first header address field 506, a second header address field 508, a first buffer address field 510, a second buffer address field 512, a first transmit timestamp 514, a second transmit timestamp 516, a buffer length field 518, and a control/status bit field 520. The example receive descriptor 504 includes a first header address field 522, a second header address field 524, a first buffer address field 526, a second buffer address field 528, a first receive timestamp field 530, a second receive timestamp field 532, a buffer length field 534, and a control/status bit field 536.

The illustrated example of FIG. 5 also includes a control bit table 538. The control bit table 538 includes a last descriptor (LD) column 540, a first descriptor (FD) column 542, a next descriptor (ND) column 544, and a description column 546. The example control/status bit field 520 of the transmit descriptor 502. The example descriptor configuration circuitry 452 causes creation of the example transmit descriptor 502 to use a single data buffer 304, which is identified in a first buffer address field 510, and a second buffer address field 512 for a 64-bit address in the in-circuit SRAM 420. Read and/or write operations repetitively occur with the single data buffer 304 and its corresponding address in the in-circuit SRAM 420. Additionally, when the ND bit is cleared (e.g., zero, “0”), the MAC 418 and the packet circuitry 414 are restricted to using only a single descriptor (repeatedly and/or otherwise iteratively) and not a descriptor ring, thereby avoiding extra bandwidth demands associated with the transfer and management of two or more descriptors 212 of a traditional descriptor ring 202. In some examples, the descriptor configuration circuitry 452 parses the descriptor (e.g., the transmit descriptor 502 and/or the receive descriptor 504) to identify the ND bit and determine a mode of operation for the SOC (e.g., isosynchronous mode having a single descriptor, no descriptor ring, a single on-circuit SRAM 420, and a common data rate). Additionally, the ND bit cleared to zero prohibits read/write activity to memory that is not within the SOC of the network control circuitry 112. In other words, the single descriptor 312 does not include any pointers to the DDR 404 and is, instead, restricted (e.g., diverted) to pointers only to the in-circuit SRAM 420 that are bus-accessible within the SOC.

The example descriptor configuration circuitry 452 causes the MAC 418 to fetch the single descriptor 312 and decode it to identify (a) the memory pointer (e.g., the 64-bit memory address of the in-circuit SRAM 420) and (b) use or non-use of a descriptor ring during fetch operations. In some examples, the packet circuitry 414 parses header information of packets to identify sample frequencies, a number of channels, a sample depth, an Ethernet frame frequency (e.g., a periodicity), a number of streams, a number of samples per frame, a number of bytes per frame, and/or a total payload (e.g., in bytes). The example MAC 418, packet circuitry 414 and service interface circuitry 124 operate at a same scheduled rate (e.g., a periodicity schedule as determined via header information).

During receive operations, such as circumstances where network data is received by the physical layer circuitry 110, the read/write circuitry 454 causes the MAC 418 to write data to a particular memory location of the in-circuit SRAM 420. Stated differently, the same memory location of the in-circuit SRAM 420 is used over-and-over (e.g., repetitively, iteratively). Once the data is written to the in-circuit SRAM 420, the service notification circuitry 456 causes the MAC 418 to send an interrupt to the packet circuitry 414 to inform and/or otherwise notify (e.g., at a rate associated with the periodicity schedule) (a) the packet circuitry 414 and (b) the service interface circuitry 124 that data is available in the in-circuit SRAM 420. In some examples, message-based SOCs use the message interrupt circuitry 416 to communicate data availability status messages and/or interrupt messages throughout the SOC. In some examples, the message interrupt circuitry 416 coordinates messaging via the downstream bus circuitry 416 (e.g., AXI downstream fabric), upstream bus circuitry 412 (e.g., AXI upstream fabric), and bus management circuitry 408 (e.g., an AXI bridge).

In response to the MAC 418 interrupt to the packet circuitry 414, the packet circuitry 414 reads the data from the in-circuit SRAM 420 at the predetermined frame rate and sends it to the service interface circuitry 124. Because both the packet circuitry 414 and the service interface circuitry 124 operate with a coordinated frame rate, software-based timing controls are not needed as the packet circuitry 414 strips out the headers before transmitting data to the service interface circuitry 124. The stripped data is pushed by the service interface circuitry 124 through the fabric (e.g., the bus management circuitry 408 or other bus technique) to reach the device control circuitry 122 for further processing. For example, audio data may cause an automobile speaker system to generate sound, or video data may cause one or more displays to render video content.

On the other hand, the service notification circuitry 456 monitors for circumstances where the device control circuitry 122 is generating a stream to be distributed to the network. Upon receipt of the data by the service interface circuitry 124, it is pushed to the packet circuitry 414 to have headers added. In some examples, the packet circuitry 414 adds AVTP headers (e.g., AVTP 1722). Unlike traditional DMA streaming, in which data is stored in off-circuit DDR (e.g., DDR 404 that is not on a same SOC or die as the network control circuitry 112), examples disclosed herein bypass off-circuit storage and instead write to a same in-circuit (e.g., circuitry that is on the same SOC or die as the network control circuitry 112) SRAM address iteratively based on pointer address information provided by the single descriptor 312. The read/write circuitry 454 causes the packet circuitry 414 to store the data to the in-circuit SRAM 420 and also notifies the MAC 418 that such storage operations (iteratively to the same address) have started. Because the MAC 418, the packet circuitry 414, and the service interface circuitry 124 all operate at the same rate, the notification to the MAC 418 permits it to obtain the stored data from the in-circuit SRAM 420 and transmit the corresponding data to the network (via the physical layer circuitry 110) at the designated rate without software assistance or further messaging efforts therebetween.

While an example manner of implementing the stream control circuitry of FIGS. 1 and 4A are illustrated in FIG. 4B, one or more of the elements, processes, and/or devices illustrated in FIG. 4B may be combined, divided, re-arranged, omitted, eliminated, and/or implemented in any other way. Further, the example mode circuitry 450, the example descriptor configuration circuitry 452, the example read/write circuitry 454, the example service notification circuitry 456, and/or, more generally, the example stream control circuitry of FIG. 4B, may be implemented by hardware alone or by hardware in combination with software and/or firmware. Thus, for example, any of the example mode circuitry 450, the example descriptor configuration circuitry 452, the example read/write circuitry 454, the example service notification circuitry 456, and/or, more generally, the example stream control circuitry, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example stream control circuitry of FIG. 4B may include one or more elements, processes, and/or devices in addition to, or instead of, those illustrated in FIG. 4B, and/or may include more than one of any or all of the illustrated elements, processes and devices.

Flowchart(s) representative of example machine readable instructions, which may be executed by programmable circuitry to implement and/or instantiate the stream control circuitry of FIG. 4B and/or representative of example operations which may be performed by programmable circuitry to implement and/or instantiate the stream control circuitry of FIG. 4B, are shown in FIG. 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 6, many other methods of implementing the example stream control circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to manage streaming. The example machine-readable instructions and/or the example operations 600 of FIG. 6 begin at block 602, at which an SOC is booted to an operating system. As described above, one or more device drivers are loaded, which may be associated with NIC devices, audio devices, video devices, etc. The example mode circuitry 450 configures the MAC 418 and service devices (e.g., service devices associated with the service interface circuitry 124) to operate in a streaming mode (block 604). In particular, the streaming mode causes the MAC 418 and the service interface circuitry 124 to operate in an isosynchronous mode in which data to/from the network is transmitted at a particular data sample frequency (e.g., transmitted/received at a constant rate with a fixed time interval in between packets).

The example descriptor configuration circuitry 452 causes the example network control circuitry 112 to create and/or otherwise generate one descriptor per stream that is stored in the in-circuit SRAM 420 (block 606). As described above, the network control circuitry 112 generates the descriptor in a manner consistent with the illustrated example of FIG. 3A (for transmission operations) and FIG. 3B (for receive operations). The descriptor(s) generated by the network control circuitry 112 include a memory address value (e.g., one or more bit address fields) to be used in a repetitive manner at the particular data sample frequency. The descriptor(s) generated by the network control circuitry 112 also include the next descriptor field (e.g., the ND column 544) set to a value of zero to identify circumstances where data transfer operations repeat the same descriptor at the identified on-chip memory address value.

The example mode circuitry 450 triggers and/or otherwise enables DMA operations to begin (block 608) after the descriptor has been generated. The example descriptor configuration circuitry 452 causes the MAC 418 to fetch and decode the generated descriptor (block 610). In particular, the descriptor informs, instructs and/or otherwise configures the MAC 418 to perform its memory read/write operations with only a single in-circuit SRAM 420 memory address, which prohibits read/write access attempts to relatively higher latency efforts to access DDR 404. Additionally, the descriptor configuration circuitry 452 instructs the MAC 418 to perform its memory read/write operations at the identified data sample frequency, in which the data sample frequency is coordinated with the packet circuitry 414 and the service interface circuitry 124. Because devices with the SOC (e.g., the network control circuitry 112) are coordinated to perform their read/write operations at a coordinated data sample frequency, computational burdens associated with interrupt management and coordination are reduced by examples disclosed herein.

The example mode circuitry 450 instantiates a transmit engine and a receive engine of the MAC 418 (block 612) to handle respective transmit/receive operations. In the event of a receive operation (block 612), such as circumstances where data packets arrive from the example physical layer circuitry 110, the read/write circuitry 454 causes the MAC 418 to write data from the network to the memory location identified by the descriptor (block 614) (e.g., at a memory location of the in-circuit SRAM 420). The service notification circuitry 456 causes the example message interrupt circuitry 416 to inform and/or otherwise message the example packet circuitry 414 and the service interface circuitry 124 that data is available in the in-circuit SRAM 420 (block 616). The messages/interrupts instantiated by the service notification circuitry 456 causes the packet processor circuitry 414 to fetch the data from in-circuit SRAM 420 (instead of DDR 404), and provide it to the service interface circuitry 124 (block 618). As such, the service interface circuitry 124 pushes the data to one or more services devices based on a frame start of the received packet (block 618). Because the physical layer circuitry 110 is receiving network packets at the coordinated data sample frequency, the packet circuitry 414 retrieves such data from the in-circuit SRAM 420, strips header information, provides payload information to the service interface circuitry 124, which is then transmitted to services/devices (e.g., the device control circuitry 122) at a predictable rate without software intervention.

In the event of a transmit operation (block 612), such as circumstances where one or more services/devices (e.g., the device control circuitry 122) generate packet data to be transmitted to the network via the example physical layer circuitry 110, the example service notification circuitry 454 monitors for such events via the message interrupt circuitry 416 (block 620). While packet data transmitted from the device control circuitry 122 may exhibit a predictable rate of transmission when it begins, the read/write circuitry 454 notifies the MAC 418 at the start of such transmission (block 622). In particular, the read/write circuitry 454 causes notification to the MAC 418 to store data to the in-circuit SRAM 420 pointed to by the descriptor 312 (block 622). The example read/write circuitry 454 causes transmission from the in-circuit SRAM 420 to the network (e.g., via the physical layer circuitry 110) at the identified data rate (block 624). Control then returns to block 612 to react to additional receive and/or transmit operations.

FIG. 7 is a block diagram of an example programmable circuitry platform 700 structured to execute and/or instantiate the example machine-readable instructions and/or the example operations of FIG. 6 to implement the stream control circuitry of FIG. 4B. The programmable circuitry platform 700 can be, for example, a server, a personal computer, a workstation, a self-learning machine (e.g., a neural network), a mobile device (e.g., a cell phone, a smart phone, a tablet such as an iPad™), an Internet appliance, a gaming console, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the example mode circuitry 450, the example descriptor configuration circuitry 452, the example read/write circuitry 454, the example service notification circuitry 456, and the example stream control circuitry 102.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIG. 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowchart of FIG. 6 to effectively instantiate the circuitry of FIG. 4B as logic circuits to perform operations corresponding to those machine readable instructions. In some such examples, the circuitry of FIG. 4B is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8.

Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIG. 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 6. As such, the FPGA circuitry 900 may be configured and/or structured to effectively instantiate some or all of the operations/functions corresponding to the machine readable instructions of the flowchart(s) of FIG. 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIG. 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIG. 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIG. 6 to perform first operation(s)/function(s), the FPGA circuitry 900 of FIG. 9 may be configured and/or structured to perform second operation(s)/function(s) corresponding to a second portion of the machine readable instructions represented by the flowchart of FIG. 6, and/or an ASIC may be configured and/or structured to perform third operation(s)/function(s) corresponding to a third portion of the machine readable instructions represented by the flowchart of FIG. 6.

It should be understood that some or all of the circuitry of FIG. 4B may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 4B may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 4B may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

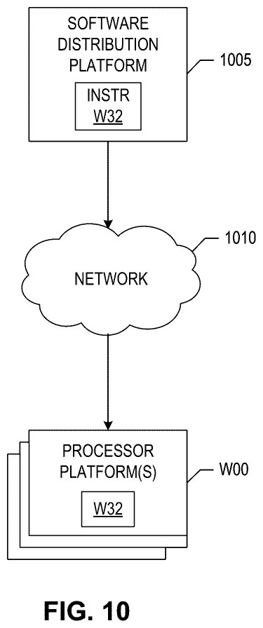

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIG. 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 6, may be downloaded to the example programmable circuitry platform 700, which is to execute the machine readable instructions 732 to implement the stream control circuitry. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that manage streaming. Examples disclosed herein divert and/or otherwise intercept traditional DMA address access that is associated with off-chip and/or otherwise off-SOC memory, such as DDR memory. Examples disclosed herein augment traditional DMA operations to utilize on-circuit memory resources that are accessible to an SOC bus, thereby reducing latency caused by traditional off-circuit memory operations. Disclosed systems, apparatus, articles of manufacture, and methods improve the efficiency of using a computing device by reducing computational resources of a host that is otherwise responsible for DMA management and packet processing tasks. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage streaming are disclosed herein. Further examples and combinations thereof include the following:

Example 1 includes a system comprising interface circuitry, and media access control (MAC) circuitry to route data from a network to a single address of a memory based on a memory address pointer at a scheduled rate.

Example 2 includes the system as defined in example 1, including first circuitry to initialize the MAC circuitry with the scheduled rate for write operations to the memory.

Example 3 includes the system as defined in example 2, wherein the MAC circuitry is to write the routed data to the single address of the memory at the scheduled rate.

Example 4 includes the system as defined in example 3, wherein the memory address pointer is a memory bypass pointer, including second circuitry to replace a default memory address pointer of the MAC circuitry with the memory bypass pointer.

Example 5 includes the system as defined in example 4, wherein the default memory pointer is associated with a dynamic memory access (DMA) operation.

Example 6 includes the system as defined in any of examples 4 or 5, wherein the MAC and the memory are on a system-on-chip (SOC), the default memory pointer is associated with an off-chip memory not included on the SOC and having a first memory operation latency, and the memory address pointer is associated with on-chip memory on the SOC having a second memory operation latency, the second memory operation latency lower than the first memory operation latency.

Example 7 includes the system as defined in example 2, including second circuitry to generate a descriptor data structure having the memory address pointer.

Example 8 includes the system as defined in any of examples 2 or 7, including third circuitry to cause the MAC circuitry to fetch the descriptor data structure once during a plurality of memory operations associated with a plurality of portions of the data.

Example 9 includes the system as defined in any of examples 2, 7 or 8, including fourth circuitry to cause the MAC circuitry to notify a service that data is available in the memory.

Example 10 includes the system as defined in any of examples 2, 7, 8 or 9, wherein the fourth circuitry is to cause the MAC circuitry to notify at a rate associated with the scheduled rate.

Example 11 includes the system as defined in example 10, wherein the MAC circuitry is a system-on-chip (SOC), the system including first circuitry to initialize the SOC for streaming based on a packet type associated with the data.

Example 12 includes the system as defined in example 11, wherein the first circuitry is to identify the packet type as one of an isosynchronous packet type or an asynchronous packet type.

Example 13 includes the system as defined in any of examples 2, 11 or 12, wherein the first circuitry is to initialize the SOC with a periodicity schedule based on the isosynchronous packet type.

Example 14 includes the system as defined in any of examples 2, 11, or 13 including a bus, the memory and the bus inside the SOC.

Example 15 includes at least one non-transitory machine-readable medium comprising machine-readable instructions to cause at least one processor circuit of a system-on-chip (SOC) to route data from a network to a single address of a memory based on a memory address pointer at a scheduled rate.

Example 16 includes the at least one non-transitory machine-readable medium as defined in example 15, wherein the machine-readable instructions cause one or more of the at least one processor circuit to initialize media access control (MAC) circuitry with the scheduled rate for write operations to the memory.

Example 17 includes the at least one non-transitory machine-readable medium as defined in example 16, wherein the machine-readable instructions cause one or more of the at least one processor circuit to cause the MAC circuitry to write the routed data to the single address of the memory at the scheduled rate.

Example 18 includes the at least one non-transitory machine-readable medium as defined in example 17, wherein the memory address pointer is a memory bypass pointer, the machine-readable instructions cause one or more of the at least one processor circuit to replace a default memory address pointer of the MAC circuitry with the memory bypass pointer.

Example 19 includes the at least one non-transitory machine-readable medium as defined in example 18, wherein the default memory pointer is associated with a dynamic memory access (DMA) operation.

Example 20 includes the at least one non-transitory machine-readable medium as defined in any of examples 18 or 19, wherein the MAC and the memory are included on the SOC, the default memory pointer is associated with an off-chip memory not included on the SOC and having a first memory operation latency, and the memory address pointer is associated with on-chip memory on the SOC having a second memory operation latency, the second memory operation latency lower than the first memory operation latency.

Example 21 includes the at least one non-transitory machine-readable medium as defined in any of examples 15-20, wherein the machine-readable instructions cause one or more of the at least one processor circuit to generate a descriptor data structure having the memory address pointer.

Example 22 includes the at least one non-transitory machine-readable medium as defined in example 21, wherein the machine-readable instructions cause one or more of the at least one processor circuit to cause the MAC circuitry to fetch the descriptor data structure once during a plurality of memory operations associated with a plurality of portions of the data.

Example 23 includes the at least one non-transitory machine-readable medium as defined in any of examples 15-20, wherein the machine-readable instructions cause one or more of the at least one processor circuit to cause the MAC circuitry to notify a service that data is available in the memory.

Example 24 includes the at least one non-transitory machine-readable medium as defined in example 23, wherein the machine-readable instructions cause one or more of the at least one processor circuit to cause the MAC circuitry to notify at a rate associated with the scheduled rate.

Example 25 includes the at least one non-transitory machine-readable medium as defined in any of examples 15-20, wherein the machine-readable instructions cause one or more of the at least one processor circuit to initialize the SOC for streaming based on a packet type associated with the data.

Example 26 includes the at least one non-transitory machine-readable medium as defined in example 25, wherein the machine-readable instructions cause one or more of the at least one processor circuit to identify the packet type as one of an isosynchronous packet type or an asynchronous packet type.

Example 27 includes the at least one non-transitory machine-readable medium as defined in example 26, wherein the machine-readable instructions cause one or more of the at least one processor circuit to initialize the SOC with a periodicity schedule based on the isosynchronous packet type.

Example 28 includes a system-on-chip (SOC) comprising interface circuitry, means for transmission to cause media access control (MAC) circuitry to route data from a network to a single address of a memory based on a memory address pointer at a scheduled rate.

Example 29 includes the system as defined in example 28, including means for mode adjustment to initialize the MAC circuitry with the scheduled rate for write operations to the memory.

Example 30 includes the system as defined in example 29, wherein the MAC circuitry is to write the routed data to a single address of the memory at the scheduled rate.

Example 31 includes the system as defined in example 30, including means for configuring a descriptor to replace a default memory address pointer of the MAC circuitry with a memory bypass pointer.

Example 32 includes the system as defined in example 31, wherein the default memory pointer is associated with a dynamic memory access (DMA) operation.

Example 33 includes the system as defined in any of examples 31 or 32, wherein the MAC and the memory are included on the SOC, the default memory pointer is associated with an off-chip memory not included on the SOC and having a first memory operation latency, and the memory bypass pointer is associated with on-chip memory on the SOC having a second memory operation latency, the second memory operation latency lower than the first memory operation latency.

Example 34 includes the system as defined in any of examples 28-33, including means for configuring a descriptor to generate a descriptor data structure having the memory address pointer.

Example 35 includes the system as defined in example 34, wherein the means for transmission is to cause the MAC circuitry to fetch the descriptor data structure once during a plurality of memory operations associated with a plurality of portions of the data.

Example 36 includes the system as defined in any of examples 28-33, including means for notification to cause the MAC circuitry to notify a service that data is available in the memory.

Example 37 includes the system as defined in example 36, wherein the means for notification is to cause the MAC circuitry to notify at a rate associated with the scheduled rate.

Example 38 includes the system as defined in any of examples 28-33, wherein the means for transmission is to initialize the SOC for streaming based on a packet type associated with the data.

Example 39 includes the system as defined in example 38, wherein the means for transmission is to identify the packet type as one of an isosynchronous packet type or an asynchronous packet type.

Example 40 includes the system as defined in example 39, wherein the means for transmission is to initialize the SOC with a periodicity schedule based on the isosynchronous packet type.

Example 41 includes a system-on-chip (SOC) comprising interface circuitry, machine-readable instructions, and at least one programmable circuit to be programmed by the machine-readable instructions to route data from a network to a single address of a memory based on a memory address pointer at a scheduled rate.

Example 42 includes the SOC as defined in example 41, wherein one or more of the at least one programmable circuit is to initialize media access control (MAC) circuitry with the scheduled rate for write operations to the memory.

Example 43 includes the SOC as defined in example 42, wherein one or more of the at least one programmable circuit is to write the routed data to the single address of the memory at the scheduled rate.

Example 44 includes the SOC as defined in example 43, wherein the memory address pointer is a memory bypass pointer, one or more of the at least one programmable circuit is to replace a default memory address pointer of the MAC circuitry with the memory bypass pointer.

Example 45 includes the SOC as defined in example 44, wherein the default memory pointer is associated with a dynamic memory access (DMA) operation.

Example 46 includes the SOC as defined in any of examples 44 or 45, wherein the MAC and the memory are included on the SOC, the default memory pointer is associated with an off-chip memory not included on the SOC and having a first memory operation latency, and the memory address pointer is associated with on-chip memory on the SOC having a second memory operation latency, the second memory operation latency lower than the first memory operation latency.

Example 47 includes the SOC as defined in any of examples 41-46, wherein one or more of the at least one programmable circuit is to generate a descriptor data structure having the memory address pointer.

Example 48 includes the SOC as defined in example 47, wherein one or more of the at least one programmable circuit is to cause media access control (MAC) circuitry to fetch the descriptor data structure once during a plurality of memory operations associated with a plurality of portions of the data.

Example 49 includes the SOC as defined in any of examples 41-46, wherein one or more of the at least one programmable circuit is to cause media access control (MAC) circuitry to notify a service that data is available in the memory.

Example 50 includes the SOC as defined in example 49, wherein one or more of the at least one programmable circuit is to cause the notification at a rate associated with the scheduled rate.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
interface circuitry; and
media access control (MAC) circuitry to route data from a network to a single address of a memory based on a memory address pointer at a scheduled rate.

2. The system as defined in claim 1, including first circuitry to initialize the MAC circuitry with the scheduled rate for write operations to the memory.

3. The system as defined in claim 2, wherein the MAC circuitry is to write the routed data to the single address of the memory at the scheduled rate.

4. The system as defined in claim 3, wherein the memory address pointer is a memory bypass pointer, including second circuitry to replace a default memory address pointer of the MAC circuitry with the memory bypass pointer.

5. The system as defined in claim 4, wherein the default memory pointer is associated with a dynamic memory access (DMA) operation.

6. The system as defined in claim 4, wherein the MAC and the memory are on a system-on-chip (SOC), the default memory pointer is associated with an off-chip memory not included on the SOC and having a first memory operation latency, and the memory address pointer is associated with on-chip memory on the SOC having a second memory operation latency, the second memory operation latency lower than the first memory operation latency.

7. The system as defined in claim 2, including second circuitry to generate a descriptor data structure having the memory address pointer.

8. The system as defined in claim 7, including third circuitry to cause the MAC circuitry to fetch the descriptor data structure once during a plurality of memory operations associated with a plurality of portions of the data.

9. The system as defined in claim 2, including fourth circuitry to cause the MAC circuitry to notify a service that data is available in the memory.

10. The system as defined in claim 9, wherein the fourth circuitry is to cause the MAC circuitry to notify at a rate associated with the scheduled rate.

11. The system as defined in claim 1, wherein the MAC circuitry is a system-on-chip (SOC), the system including first circuitry to initialize the SOC for streaming based on a packet type associated with the data.

12. The system as defined in claim 11, wherein the first circuitry is to identify the packet type as one of an isosynchronous packet type or an asynchronous packet type.

13. The system as defined in claim 12, wherein the first circuitry is to initialize the SOC with a periodicity schedule based on the isosynchronous packet type.

14. The system as defined in claim 11, including a bus, the memory and the bus inside the SOC.

15. At least one non-transitory machine-readable medium comprising machine-readable instructions to cause at least one processor circuit of a system-on-chip (SOC) to route data from a network to a single address of a memory based on a memory address pointer at a scheduled rate.

16. The at least one non-transitory machine-readable medium as defined in claim 15, wherein the machine-readable instructions cause one or more of the at least one processor circuit to initialize media access control (MAC) circuitry with the scheduled rate for write operations to the memory.

17. The at least one non-transitory machine-readable medium as defined in claim 16, wherein the machine-readable instructions cause one or more of the at least one processor circuit to cause the MAC circuitry to write the routed data to the single address of the memory at the scheduled rate.

18. The at least one non-transitory machine-readable medium as defined in claim 17, wherein the memory address pointer is a memory bypass pointer, the machine-readable instructions cause one or more of the at least one processor circuit to replace a default memory address pointer of the MAC circuitry with the memory bypass pointer.

19. The at least one non-transitory machine-readable medium as defined in claim 18, wherein the default memory pointer is associated with a dynamic memory access (DMA) operation.

20. The at least one non-transitory machine-readable medium as defined in claim 18, wherein the MAC and the memory are included on the SOC, the default memory pointer is associated with an off-chip memory not included on the SOC and having a first memory operation latency, and the memory address pointer is associated with on-chip memory on the SOC having a second memory operation latency, the second memory operation latency lower than the first memory operation latency.

21. The at least one non-transitory machine-readable medium as defined in claim 15, wherein the machine-readable instructions cause one or more of the at least one processor circuit to generate a descriptor data structure having the memory address pointer.

22. The at least one non-transitory machine-readable medium as defined in claim 21, wherein the machine-readable instructions cause one or more of the at least one processor circuit to cause the MAC circuitry to fetch the descriptor data structure once during a plurality of memory operations associated with a plurality of portions of the data.

23. The at least one non-transitory machine-readable medium as defined in claim 15, wherein the machine-readable instructions cause one or more of the at least one processor circuit to cause the MAC circuitry to notify a service that data is available in the memory.

24. The at least one non-transitory machine-readable medium as defined in claim 23, wherein the machine-readable instructions cause one or more of the at least one processor circuit to cause the MAC circuitry to notify at a rate associated with the scheduled rate.

25. The at least one non-transitory machine-readable medium as defined in claim 15, wherein the machine-readable instructions cause one or more of the at least one processor circuit to initialize the SOC for streaming based on a packet type associated with the data.

26. The at least one non-transitory machine-readable medium as defined in claim 25, wherein the machine-readable instructions cause one or more of the at least one processor circuit to identify the packet type as one of an isosynchronous packet type or an asynchronous packet type.

27. The at least one non-transitory machine-readable medium as defined in claim 26, wherein the machine-readable instructions cause one or more of the at least one processor circuit to initialize the SOC with a periodicity schedule based on the isosynchronous packet type.

28. A system-on-chip (SOC) comprising:
interface circuitry;
means for transmission to cause media access control (MAC) circuitry to route data from a network to a single address of a memory based on a memory address pointer at a scheduled rate.

29. The system as defined in claim 28, including means for mode adjustment to initialize the MAC circuitry with a the scheduled rate for write operations to the memory.

30. The system as defined in claim 29, wherein the MAC circuitry is to write the routed data to a single address of the memory at the scheduled rate.

31. The system as defined in claim 30, including means for configuring a descriptor to replace a default memory address pointer of the MAC circuitry with a memory bypass pointer.

32. The system as defined in claim 31, wherein the default memory pointer is associated with a dynamic memory access (DMA) operation.

33. The system as defined in claim 31, wherein the MAC and the memory are on included on the SOC, the default memory pointer is associated with an off-chip memory not included on the SOC and having a first memory operation latency, and the memory bypass pointer is associated with on-chip memory on the SOC having a second memory operation latency, the second memory operation latency lower than the first memory operation latency.

34. The system as defined in claim 28, including means for configuring a descriptor to generate a descriptor data structure having the memory address pointer.

35. The system as defined in claim 34, wherein the means for transmission is to cause the MAC circuitry to fetch the descriptor data structure once during a plurality of memory operations associated with a plurality of portions of the data.

36. The system as defined in claim 28, including means for notification to cause the MAC circuitry to notify a service that data is available in the memory.

37. The system as defined in claim 36, wherein the means for notification is to cause the MAC circuitry to notify at a rate associated with the scheduled rate.

38. The system as defined in claim 28, wherein the means for transmission is to initialize the SOC for streaming based on a packet type associated with the data.

39. The system as defined in claim 38, wherein the means for transmission is to identify the packet type as one of an isosynchronous packet type or an asynchronous packet type.

40. The system as defined in claim 39, wherein the means for transmission is to initialize the SOC with a periodicity schedule based on the isosynchronous packet type.

41. A system-on-chip (SOC) comprising:
interface circuitry;
machine-readable instructions; and
at least one programmable circuit to be programmed by the machine-readable instructions to route data from a network to a single address of a memory based on a memory address pointer at a scheduled rate.

42. The SOC as defined in claim 41, wherein one or more of the at least one programmable circuit is to initialize media access control (MAC) circuitry with the scheduled rate for write operations to the memory.

43. The SOC as defined in claim 42, wherein one or more of the at least one programmable circuit is to write the routed data to the single address of the memory at the scheduled rate.

44. The SOC as defined in claim 43, wherein the memory address pointer is a memory bypass pointer, one or more of the at least one programmable circuit is to replace a default memory address pointer of the MAC circuitry with the memory bypass pointer.

45. The SOC as defined in claim 44, wherein the default memory pointer is associated with a dynamic memory access (DMA) operation.

46. The SOC as defined in claim 44, wherein the MAC and the memory are included on the SOC, the default memory pointer is associated with an off-chip memory not included on the SOC and having a first memory operation latency, and the memory address pointer is associated with on-chip memory on the SOC having a second memory operation latency, the second memory operation latency lower than the first memory operation latency.

47. The SOC as defined in claim 41, wherein one or more of the at least one programmable circuit is to generate a descriptor data structure having the memory address pointer.

48. The SOC as defined in claim 47, wherein one or more of the at least one programmable circuit is to cause media access control (MAC) circuitry to fetch the descriptor data structure once during a plurality of memory operations associated with a plurality of portions of the data.

49. The SOC as defined in claim 41, wherein one or more of the at least one programmable circuit is to cause media access control (MAC) circuitry to notify a service that data is available in the memory.

50. The SOC as defined in claim 49, wherein one or more of the at least one programmable circuit is to cause the notification at a rate associated with the scheduled rate.
